(19) United States
(12) Patent Application Publication
(10) Pub. No.: US 2020/0115622 A1
(43) Pub. Date: Apr. 16, 2020

(54) PROCESS FOR THERMAL DEGRADATION OF A BIOPOLYMER

(71) Applicant: CARGILL, INCORPORATED, Wayzata, MN (US)

(72) Inventors: Tryg Richard JENSEN, Roseville, MN (US); Jeffrey J. MALSAM, Minneapolis, MN (US); Eric Stanley SUMNER, Minneapolis, MN (US)

(73) Assignee: CARGILL, INCORPORATED, Wayzata, MN (US)

(21) Appl. No.: 16/713,937

(22) Filed: Dec. 13, 2019

Related U.S. Application Data
(63) Continuation of application No. 15/876,580, filed on Jan. 22, 2018.
(60) Provisional application No. 62/448,616, filed on Jan. 20, 2017.

(51) Int. Cl. C09K 8/588; C08L 5/00; C09K 8/08; C08B 37/00

(52) U.S. Cl. CPC C09K 8/588; C08B 37/0024; C09K 8/08; C08L 5/00

(57) ABSTRACT

Disclosed herein is a process for reducing viscosity of an aqueous composition comprising a biopolymer, comprising: obtaining an aqueous composition comprising 1,3 beta glucan wherein the aqueous composition has an initial viscosity and heating the aqueous composition to a desired temperature, preferably in combination with a desired shear rate, to reduce viscosity by at least 50%.

### PRIORITY

This application is a continuation of U.S. patent application Ser. No. 15/876,580, filed Jan. 22, 2018, which claims the benefit of U.S. Provisional Patent Application No. 62/448,616, filed Jan. 20, 2017, which are hereby incorporated by reference in their entirety.

### TECHNICAL FIELD

The present invention relates to a process for thermally degrading a biopolymer composition preferably to aid in oil-water separation for enhanced oil recovery applications.

### BACKGROUND

The viscosity characteristics of biopolymers make them desirable candidates for enhanced oil recovery (“EOR”) applications. When producing oil during an oil recovery project, biopolymers may still be present in the produced oil-water mixture, causing an increase in viscosity. Accordingly, a biopolymer solution that works with preexisting techniques and equipment used for oil-water separation is desirable.

### BRIEF SUMMARY

Disclosed herein is a process for reducing viscosity of an aqueous composition comprising a biopolymer, the process comprising obtaining an aqueous composition comprising 1,3 beta glucan wherein the aqueous composition has an initial viscosity, and heating the aqueous composition to a desired temperature, preferably in combination with a desired shear rate, to reduce the initial viscosity by at least 50%.

One aspect is a process for reducing viscosity, comprising obtaining an aqueous composition comprising 1,3 beta glucan wherein the aqueous composition has an initial viscosity, and heating the aqueous composition to a temperature ranging from about 120 C to about 200 C and applying shear to the aqueous composition at a shear rate of at least 1,000/s for a period of time sufficient to achieve at least a 50% reduction of the initial viscosity.

Another aspect is a process for reducing viscosity of an aqueous composition comprising 1,3 beta glucan, comprising recovering an oil-water mixture from an oil-bearing reservoir, wherein the aqueous phase of the oil-water mixture comprises 1,3 beta glucan and wherein the aqueous phase is of an initial viscosity, and heating the oil-water mixture to a temperature ranging from about 130 C to about 200 C for a period of time sufficient to achieve a final viscosity which is at least a 50% reduction of the initial viscosity.

### FIGURES

FIGS. 1A, 1B, and 2 illustrate viscosity drop of an aqueous composition comprising scleroglucan within desired temperature and shear rate ranges.

### DEFINITIONS

Reference to “oil” used herein means any type of oil, namely light oil, heavy oil, and/or bituminous oil.

Reference to “oil-water mixture” used herein means the mixture that is directly recovered from an oil-bearing reservoir. The oil-water mixture can be a two phase system comprising oil and water. Alternatively, the oil-water mixture can be a three phase system comprising oil, water, and gas.

Reference to “aqueous phase” used herein means a water phase comprising beta glucan, and more specifically a water phase in a oil-water mixture. In an oil-water mixture, the aqueous phase comprises a substantial majority of the beta glucan.

Reference to “biopolymer” used herein means a beta glucan composition.

Preferred aspects of beta glucans are further described herein.

Reference to an “initial viscosity” means the viscosity, determined at a temperature of 100 C, of an aqueous phase comprising beta glucan.

Reference to a “final viscosity” means the viscosity of the aqueous phase after the viscosity reduction method described herein is carried out.

Reference to a “reduction in viscosity” means the difference between the final viscosity and the initial viscosity.

Reference to a “return viscosity” means the viscosity of the aqueous phase after the viscosity reduction method described herein has been carried out and after the aqueous phase is returned to a temperature of 100 C.

### DETAILED DESCRIPTION

Described herein is a method to reduce the viscosity of an oil-water mixture, by reducing the viscosity of an aqueous phase in the oil-water mixture, wherein the aqueous phase comprises 1,3 beta glucan. It shall be understood that this viscosity reduction method is applicable for oil-water mixtures comprising 1,3 beta glucan wherein the triple helix structure of the beta glucan remains primarily intact and/or other aqueous beta glucan compositions. The viscosity reduction method can be applied to aqueous phases comprising beta glucan, irrespective of enhanced oil recovery applications, and more particularly to an aqueous phase of an oil-water mixture.

The viscosity reduction method described herein can occur in advance of oil-water separation, during oil-water separation, or a combination of both. Accordingly, it shall be understood that while the method is described as being applied to an aqueous phase of an oil-water mixture, it encompasses application to the oil-water mixture collectively, particularly in aspects where oil-water separation has not yet occurred. It shall be understood that by applying the method to an oil-water mixture collectively, the aqueous phase consequently achieves the viscosity reduction desired and described herein.

The viscosity reduction method reduces the viscosity of an aqueous phase comprising 1,3 beta glucan by at least 50% by increasing the temperature of the aqueous phase, and in some aspects, introducing the aqueous phase to a particular shear rate.

Preferred aspects of 1,3 beta glucans described herein are polysaccharides classified as 1,3 beta-D-glucans, and even more preferably polysaccharides classified as 1,3-1,6 beta-D-glucans and modifications thereof. According to aspects herein, the beta glucans comprise a main chain from beta-1,3-glycosidically bonded glucose units, and side groups which are formed from glucose units and are beta-1,6-glycosidically bonded thereto.

Fungal strains which secrete such glucans are known to those skilled in the art. Examples comprise Schizophyllum commune, Sclerotium rolfsii, Sclerotium glucanicum, Monilinla fructigena, Lentinula edodes or Botrygs cinera. The fungal strains used are preferably Schizophyllum commune or Sclerotium rolfsii.

Particularly preferred beta glucans for use herein is “scleroglucan” (or, a branched BDG with one out of three glucose molecules of the beta-(1,3)-backbone being linked to a side D-glucose unit by a (1,6)-beta bond produced from, e.g., fungi of the Sclerotium).

Another particularly preferred beta glucan for use herein is “schizophyllan” (a branched BDG having one glucose branch for every third glucose residue in the beta-(1,3)-backbone produced from, e.g., the fungus Schizophyllan commune).

For both onshore and offshore applications, the 1,3 beta glucan composition may come in a solid form, concentrated pumpable form, or fermentation broth form; and may be reconstituted/diluted under specific procedures to achieve desirable characteristics for EOR as described in co-pending patent applications, International PCT Application PCT/US17/024464, PCT/US17/024477, and PCT/US17/036730, which are hereby incorporated by reference in their entirety. A further example of such a procedure can be found in U.S. Patent Publication No. 2012/0205099.

Oil-water mixtures typically recovered from an oil reservoir via enhanced oil recovery techniques typically comprise an aqueous phase having less than about 10 g/l of a beta glucan composition. In more preferable aspects, the aqueous phase comprises less than about 8 g/l of a beta glucan composition. In even more preferable aspects, the aqueous phase comprises less than about 6 g/l of a beta glucan composition. One skilled in the art will appreciate that the presence of beta glucan in an aqueous phase consequently increases the viscosity of the aqueous phase. The increased viscosity may present challenges in utilizing pre-existing techniques and equipment for oil-water separation as an increase in viscosity can disrupt the functionality of such techniques and equipment. Accordingly, providing a solution to this increased viscosity problem is desirable.

In aspects where a shear rate is applied, the method comprises heating the aqueous phase to a temperature ranging from about 120 C to about 200 C, and in other aspects to a temperature ranging from about 130 C to about 190 C, about 140 C to about 180 C, and about 150 C to about 170 C. In the most preferred aspect, the method comprises heating the aqueous phase to a temperature ranging from about 135 C to about 175 C.

In aspects where a shear rate is not applied, the viscosity reduction method comprises heating the aqueous phase to a temperature ranging from about 130 C to about 200 C, and in other aspects to a temperature ranging from about 140 C to about 180 C, and about 150 C to about 170 C. In the most preferred aspect, the method comprises heating the aqueous phase to a temperature ranging from about 140 C to about 175 C.

In the various aspects, the at least 50% reduction in viscosity occurs within a time range of 2 seconds to about 60 minutes, the time range is more preferably 2 seconds to about 40 minutes, 5 seconds to about 30 minutes, 10 seconds to about 10 minutes, 30 seconds to about 8 minutes, and about 2 minutes to about 8 minutes. In a period of time ranging from about 2 to about 8 minutes, the initial viscosity of the aqueous phase is reduced by at least about 50%, more preferably the viscosity of the aqueous phase is reduced by at least about 60%, about 70%, about 80%, and most preferably about 90% to achieve a final viscosity.

Furthermore, under this method, the return viscosity is at least 20% below the initial viscosity.

In methods comprising the application of shear, mechanical energy is applied to the aqueous phase in the form of a shear rate (SI unit of measure in reciprocal seconds) ranging from about 1,000/s to about 75,000/s at the temperature ranges described above. In preferred aspects, the shear rate ranges from 1,000/s to about 30,000/s and more preferably 1,000/s to about 10,000/s.

Beta glucans typically maintain viscosity when subjected to this shear rate at ambient temperatures. Surprisingly, it was found that by applying shear and temperature to the aqueous phase, viscosity degradation occurs at lower temperatures.

It shall be understood that the aqueous phase does not have to be under shear for the entire temperature hold time. However if applied, mechanical energy should be applied at least while the aqueous phase is at the specified temperature. Accordingly, examples of methods/equipment that can be used to impart the desired shear rate include applying shear at an exit of a shell or tube heat exchanger, incorporating a pressure drop through a nozzle or orifice; or continuously applied shear, like turbulent flow in a pipe or a mechanical device, like an agitator.

Without being bound to any particular theory, it is believed that at a certain temperature, and in some aspects combined with mechanical energy, the structure of the beta glucan begins to thermally degrade (i.e., the triple helix structure of the beta glucan begins to disassociate into single strands) thereby causing a reduction in viscosity. It is also known that the very basic conditions and the addition of hydrogen bond disrupting solvents, like urea, degrade the viscosity of beta glucan solutions by dissociating triple helices into single strands. Accordingly, this method is applicable for oil-water mixtures comprising beta glucan wherein the triple helix structure is intact and there is no solvent or pH related reason why the triple helix is disassociating into single strands.

### Materials & Procedures

### Method of Making Scleroglucan Described in the Examples

Using a 5000 liter jacketed vessel with moderate agitation, 7 g/L of commercial Actigum CS6 from Cargill is added to 2400 liters of 11.8° C. water and mixed for 1 hour. After an hour of mixing, the vessel is heated to 85° C. and left under agitation for 12 hours without temperature control. After 12 hours the temperature is 41.3° C. and the vessel is reheated to 80° C. and passed through a Guerin homogenizer at 200 bar of pressure and 300 l/hr.

The homogenized mixture is cooled to 50° C. 4 g/L of CaCl₂*2H₂O was added. pH is reduced to 1.81 using 20% HCl. This mixture is agitated for 30 minutes to enable precipitation of oxalic acid.

After maturation, the solution is adjusted back to 5.62 pH using 10% Na₂CO₃ and heated to 85° C. and left under agitation without temperature control for 14 hours the reheated to 80° C.

After reaching 80° C. 20 g/L of Dicalite 4158 filter aid is added to the vessel and mixed for 10 minutes.

After mixing, the solution is fed to a clean Choquenet 12 m² press filter with 25080 AM membranes at 1400 L/hr recycling the product back to the feed tank for 10 minutes. At the end of recycle, the flow is adjusted to 1300 L/hr and passed through the filter. Once the tank is empty an additional 50 liters of water is pushed into the filter. The fluid from this water flush and a 12 bar compression of the cake is both added to the collected permeate. The filter is cleaned after use.

The filtered permeate, water flush, and compression fluid is agitated and heated back to 80° C.

The heated mixture has 6 kg of Dicalite 4158 added and mixed for 10 minutes. At 1400 L/hr this solution is recycled through a clean Choquenet 12 m² press filter with 25080 AM membranes at 1400 L/hr for 15 minutes. After the recycle, the tank is passed through the filter at 1400 L/hr.

Without cleaning the filter, 5.33 g/L of Clarcel® DICS and 6.667 g/L of Clarcel® CBL is added to the mixture and agitated for one hour while maintaining temperature at 80° C. This mixture is then recycled through the Dicalite coated Choquenet 12 m² press filter with 25080 AM membranes at 1400 L/hr for 15 minutes. After the recycle, the tank is passed through the filter at 1350 L/hr. An additional 50 liters of flush water is pushed through the filter and collected as permeate as well. Compression fluid from the filter is not captured.

This twice filtered material is heated to 85° C. and left agitated without temperature control for 14 hours. At this point the material is reheated to 80° C. for a third filtration step.

The heated mixture has 6 kg of Dicalite 4158 added and mixed for 10 minutes. At 1400 L/hr this solution is recycled through a clean Choquenet 12 m² press filter with 25080 AM membranes at 1400 L/hr for 15 minutes. After the recycle, the tank is passed through the filter at 1450 L/hr.

Without cleaning the filter, 5.33 g/L of Clarcel® DICS and 6.667 g/L of Clarcel® CBL is added to the mixture and agitated for one hour while maintaining temperature at 80° C. This mixture is then recycled through the Dicalite coated Choquenet 12 m² press filter with 25080 AM membranes at 1600 L/hr for 15 minutes. After the recycle, the tank is passed through the filter at 1700 L/hr. An additional 50 liters of flush water is pushed through the filter and collected as permeate as well. Compression fluid from the filter is not captured.

The triple filtered permeate is cooled to 60° C. and mixed with 83% isopropyl alcohol (IPA) at a 1:2 ratio, 2 g IPA solution for each g of scleroglucan solution. This precipitates scleroglucan fibers which can be mechanical separated from the bulk solution. In this example, a tromel separator is used to partition the precipitated fibers from the bulk liquid solution.

After recovery of the fibers they are washed with another 0.5 g 83% IPA solution for each 1 g of initial triple filtered permeate scleroglucan solution.

Wash fibers are dried in an ECI dryer with 95° C. hot water for 1 hour and 13 minutes to produce a product with 89.3% dry matter. This material is ground up and sieved to provide powder smaller in size than 250 micron. This final ground scleroglucan material is used to carry out the examples below.

### EXAMPLES

### Example #1

Into a small beaker, a mass balance is used to add 80 mg of scleroglucan made according to the description above. After adding scleroglucan, 26 mL of deionized water at room temperature was added to the beaker. The solution is then mixed with an IKA® T25 digital Ultra TURRAX® at 16,600 rpm for 2 minutes, at which point the solution is a single phase with no visible solid particles.

Roughly 16 mL of the solution is used to fill the sample tube of the Flucon Fluid Control GmbH® QVis Quartz viscometer. After adding solution, the seal of the tube housing should be tight enough to prevent leaks of sample if heated above 100° C. and exceeds the boiling point of water. This tube is then submerged up to the top of the threads in a hot oil bath and calibrated to read 200 mPa·s of viscosity at 90° C.

The viscometer vibrates at 56 kHz, imparting 56,000 l/s of shear to the solution

After preparing and calibrating the viscometer, it is set to continuous monitoring and provides a viscosity and temperature reading every 8 seconds. The hot oil bath temperature is slowly heated and viscosity is tracked until reaching 137° C. At this point the tube is removed from the hot oil bath and starts cooling back down to 80° C.

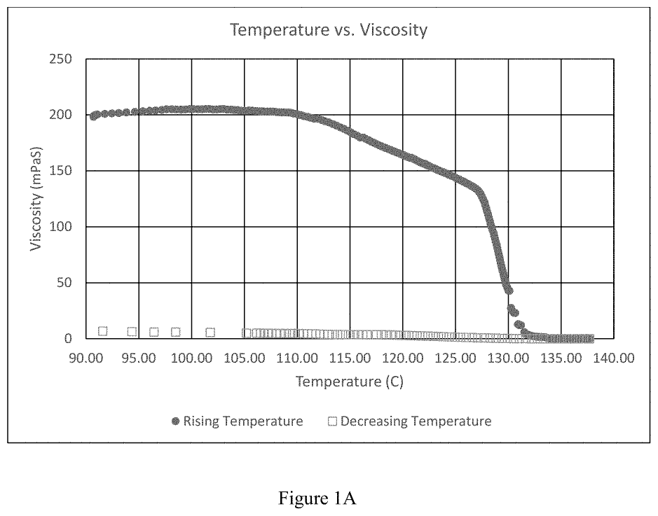

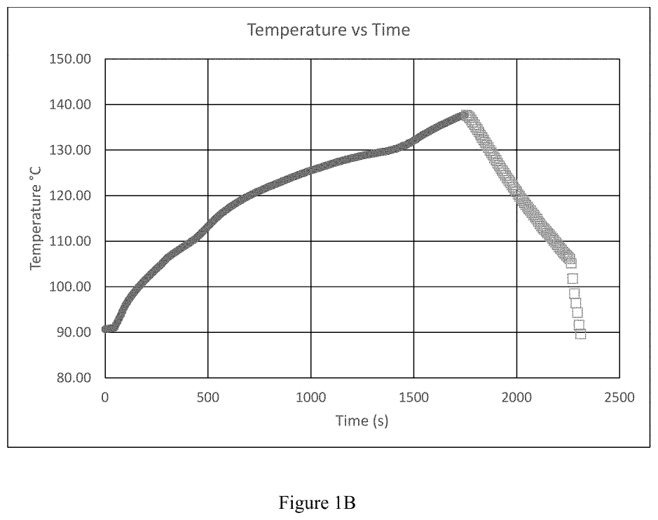

As can be seen from FIGS. 1A and 1B, there is a slow viscosity decrease as it heats from the temperature vs. viscosity relationship of the solution and then an abrupt drop between 126° C. and 133° C., where the solution experiences a greater than 95% reduction in viscosity in 8 minutes. Table 1 shows the extent of viscosity decrease over time as the heating occurs, with greater than 50% viscosity reduction in 4.3 minutes and greater than 80% viscosity reduction in 6 minutes. Furthermore, cooling the solution demonstrates a return viscosity at a value greater than a 20% reduction from the initial viscosity.

TABLE 1

| | | | | | Viscosity | |
|---|---|---|---|---|---|---|
| | Viscosity | Time | Viscosity | Time | Reduction | Time |
| Temperature | (Heating) | (Heating) | (Cooling) | (Cooling) | from 126° C. | from 126° C. |
| ° C. | mPa · s | s | mPa · s | S | % | Min |
| 120 | 162.4 | 722 | 3 | 2006 | | |
| 126 | 136.7 | 1064 | 1 | 1915 | 0% | 0 |
| 128 | 97.2 | 1223 | 0.6 | 1892 | 29% | 2.7 |
| 129 | 62.9 | 1322 | 0.4 | 1877 | 54% | 4.3 |
| 130 | 24.7 | 1421 | 0.2 | 1862 | 82% | 6.0 |
| 133.5 | 1.3 | 1550 | 0.1 | 1824 | 99% | 8.1 |

### Example #2

Into a small beaker, a mass balance is used to add 80 mg of scleroglucan made according to the description above. After adding scleroglucan, 26 mL of salt water (TDS 99,000 mg/L) at room temperature was added to the beaker. The solution is then mixed with an IKA® T25 digital Ultra TURRAX® at 16,600 rpm for 2 minutes, at which point there solution is a single phase with no visible solid particles.

Roughly 16 mL of the solution is used to fill the sample tube of the Flucon Fluid Control GmbH® QVis Quartz viscometer. After adding solution, the seal of the tube housing must be tight enough to prevent leaks as sample if heated above 100° C. and exceeds the boiling point of water. This tube was then submerged up to the top of the threads in a hot oil bath and calibrated to read 100 mPa·s of viscosity at 80° C.

The viscometer vibrates at 56 kHz, imparting 56,000 l/s of shear to the solution

After preparing and calibrating the viscometer, it is set to continuous monitoring and provides a viscosity and temperature reading every 8 seconds. The sample was then placed in a hot bath at a temperature of 155° C.

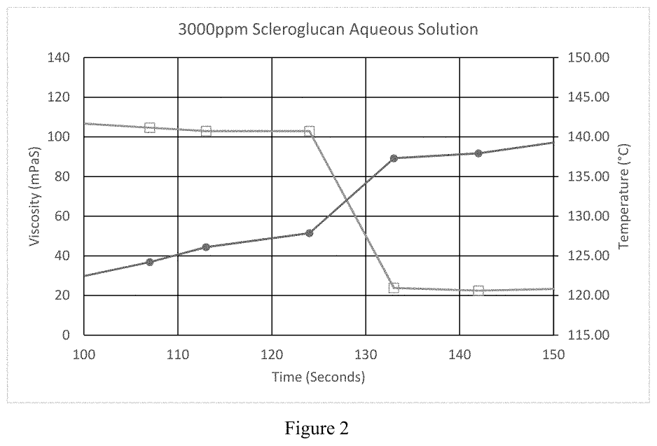

As can be seen from FIG. 2 (viscosity represented as squares, temperature represented as circles), there is an abrupt drop between 128° C. and 138° C., where the solution experiences a greater than 75% reduction in viscosity in 8 seconds.

### Example #3

Into a small beaker, a mass balance is used to add 80 mg of scleroglucan made according to the description above. After adding scleroglucan, 26 mL of salt water (TDS 99,000 mg/L) at room temperature is added to the beaker. The solution was then mixed with an IKA® T25 digital Ultra TURRAX® at 16,600 rpm for 5 minutes, at which point the solution is a single phase with no visible solid particles.

Roughly 16 mL of the solution is used to fill the sample tube of the Flucon Fluid Control GmbH® QVis Quartz viscometer. After adding solution, the seal of the tube housing must be tight enough to prevent leaks as sample if heated above 100° C. and exceeds the boiling point of water. This tube was then submerged up to the top of the threads in a hot oil bath and calibrated to read 100 mPa·s of viscosity at 77° C.

At this point the quartz probe was turned off and disconnected from the controller. The sample was then heated to 135° C. and left at 135° C. for 20 minutes; there is no shear during any part of this heating step. After 20 minutes, the sample is cooled back down to 80° C. The quartz probe is reconnected to the controller and the viscosity is measured. Measurement at 79° C. is 108 mPa·s. This example demonstrates the beneficial impact shear rate in combination with temperature provides in viscosity reduction.

1. A method of making a 1,3-1,6 beta-D-glucan powder, the method comprising:
filtering an aqueous solution comprising a 1,3-1,6 beta-D-glucan, to provide a filtered aqueous solution;
precipitating 1,3-1,6 beta-D-glucan fibers from the filtered aqueous solution;
removing the 1,3-1,6 beta-D-glucan fibers from the filtered aqueous solution;
drying the 1,3-1,6 beta-D-glucan fibers;
grinding the dried 1,3-1,6 beta-D-glucan fibers; and
sieving the dried ground 1,3-1,6 beta-D-glucan fibers to provide a 1,3-1,6 beta-D-glucan powder smaller in size that 250 microns;
wherein an aqueous solution comprising the 1,3-1,6 beta-D-glucan powder and having an initial viscosity heated to a temperature ranging from about 120° C. to about 200° C. and sheared at a shear rate of at least 1,000/s provides a final viscosity that is at least a 50% reduction of the initial viscosity.

2. The method of claim 1, wherein the filtering comprises filtering the aqueous solution comprising the 1,3-1,6 beta-D-glucan through a press filter.

3. The method of claim 1, wherein the filtering comprises adding filter aid to the aqueous solution comprising the 1,3-1,6 beta-D-glucan and removing the filter aid from the aqueous solution during the filtering.

4. The method of claim 1, further comprising filtering the aqueous solution comprising the 1,3-1,6 beta-D-glucan more than one time.

5. The method of claim 1, further comprising precipitating oxalic acid from the aqueous solution comprising the 1,3-1,6 beta-D-glucan powder.

6. The method of claim 1, wherein the aqueous solution heated to the temperature and sheared at the shear rate from about 2 seconds to about 60 minutes provides the final viscosity.

7. The method of claim 1, wherein the final viscosity is at least a 60% reduction of the initial viscosity.

8. The method of claim 1, wherein the final viscosity is at least a 70% reduction of the initial viscosity.

9. The method of claim 1, wherein the final viscosity is at least an 80% reduction of the initial viscosity.

10. The method of claim 1, wherein the final viscosity is at least a 90% reduction of the initial viscosity.

11. The method of claim 1, wherein the 1,3-1,6 beta-D-glucan is scleroglucan or schizophyllan.

12. The method of claim 1, wherein the shear rate ranges from about 1,000/s to about 75,000/s.

13. The method of claim 1, wherein the shear rate ranges from about 1,000/s to about 30,000/s.

14. The method of claim 1, wherein the shear rate ranges from about 1,000/s to about 10,000/s.

15. The method of claim 1, wherein the aqueous solution heated to a temperature of about 135° C. to about 175° C. and sheared at the shear rate provides the final viscosity.

16. The method of claim 1, wherein the aqueous solution heated to a temperature of about 140° C. to about 175° C. and sheared at the shear rate provides the final viscosity.

17. The method of claim 1, wherein the aqueous solution heated to a temperature of about 150° C. to about 170° C. and sheared at the shear rate provides the final viscosity.

18. The method of claim 1, wherein the aqueous solution comprising the 1,3-1,6 beta-D-glucan powder comprises less than 10 g/L of the 1,3-1,6 beta-D-glucan powder.

19. The method of claim 1, wherein the aqueous solution comprising the 1,3-1,6 beta-D-glucan powder comprises less than 8 g/L of the 1,3-1,6 beta-D-glucan powder.

20. The method of claim 1, wherein the aqueous solution comprising the 1,3-1,6 beta-D-glucan powder comprises less than 6 g/L of the 1,3-1,6 beta-D-glucan powder.
